(19) United States
(12) Patent Application Publication
(10) Pub. No.: US 2024/0028647 A1
(43) Pub. Date: Jan. 25, 2024

(54) SYSTEMS AND METHODS TO ORDER COSMETIC PRODUCTS IN A SKINCARE ROUTINE TO MAXIMIZE PRODUCT EFFICACY

(71) Applicant: SKIN POSI INC., Los Angeles, CA (US)

(72) Inventors: Taylor BABAIAN, Los Angeles, CA (US); Narendra PINNAMANEMI, Los Angeles, CA (US)

(21) Appl. No.: 18/265,174

(22) PCT Filed: Dec. 3, 2021
(86) PCT No.: PCT/US21/61858

§ 371 Date: Jun. 2, 2023

Related U.S. Application Data
(60) Provisional application No. 63/121,621, filed on Dec. 4, 2020.

(51) Int. Cl. G06F 16/9035; G06F 16/904

(52) U.S. Cl. CPC G06F 16/9035; G06F 16/904

(57) ABSTRACT

This paper describes the methods and systems for placing products in a routine to maximize product effectiveness. Consumers' product profiles are created by collecting personal user information, concerns, and product information in their routine. A product efficacy system categorizes the products and sorts them in the proper order based on cosmetic ingredients.

### CROSS-REFERENCES TO RELATED APPLICATIONS

This application claims benefit of U.S. Provisional Patent Application No. 63/121,621 filed Dec. 4, 2020, the specification of which is incorporated herein in its entirety by reference.

### FIELD OF THE INVENTION

The present invention is directed to machine learning systems that utilize a consumer's personal attributes and current skincare routine to offer cosmetic products to optimize and/or complete said skincare routine in a manner that best suits the consumer's personal attributes and maximizes product efficacy.

### BACKGROUND OF THE INVENTION

Cosmetic retailers like Sephora offer skincare recommendations and a step-by-step guide to using them in a recommended order by having users take a skin quiz. Such an order example may be Step 1: Cleanser, Step 2: Treatment, Step 3: Moisturizer, Step 4: Sunscreen, Step 5: Eye Cream, Face Mask. However, the order by which products are used can impact their effectiveness. For example, an eye cream, which is designed for the thinnest area of the skin being used after a sunscreen, which is often used as a last step in a skincare routine can minimize the effectiveness of the eye cream as ingredients in sunscreens may block the ingredients from the eye cream from making contact with the skin. The misinformation can impact both consumers and brands as consumers may assume an ineffective product, leading to bad product reviews that may deter new consumers from using the product. Thus, there exists a present need for an automated service that accepts a user's current skincare routine and offers products to complete said skincare routine to maximize product efficacy.

### BRIEF SUMMARY OF THE INVENTION

It is an objective of the present invention to provide systems and methods that allow for automated ordering, optimization, and completion of a skincare routine to maximize product efficacy, as specified in the independent claims. Embodiments of the invention are given in the dependent claims. Embodiments of the present invention can be freely combined with each other if they are not mutually exclusive.

The present invention features a system for accepting a user's personal attributes and skincare routine in order to offer cosmetic products that complete said skincare routine in a manner that best suits the user's personal attributes and maximizes product efficacy. The system may comprise a consumer profile comprising personal attributes, products in the user's current skincare routine, an ordering of said products, and other relevant information. The system may further comprise a device and a product efficacy system utilizing machine learning based on a training set of potential characteristics of a user matched to ingredients that interact well with said user and other ingredients. Data from the consumer profile may be transmitted to the product efficacy system, which will utilize machine learning to select a plurality of products from the product database based on a plurality of product attributes that correspond to the plurality of consumer attributes and the skincare routine. The plurality of products selected by the product efficacy system may be displayed on the device.

The present invention features a method for accepting a user's personal attributes and a skincare routine in order to reorder said skincare routine and offer cosmetic products that optimize and/or complete said skincare routine in a manner that best suits the user's personal attributes and maximizes product efficacy. The method may comprise maintaining a systematic product database of cosmetic products categorized based on a plurality of product attributes. The method may further comprise receiving a consumer profile and a current skincare routine from the user. The method may further comprise finding each cosmetic product of the skincare routine in the product database. The method may further comprise identifying a function for each cosmetic product of the skincare routine and categorizing each product of the skincare routine by function and identifying if more than one product has the same function. If more than one product has the same function, the product efficacy system may utilize the product database to order products sharing a function into a hierarchy to be displayed to the user in order to choose a preferred product from said hierarchy. The plurality of products of the skincare routine are then reordered based on an optimal ordering of product categories. This is repeated until each step has at most one product. The optimized skincare routine may be displayed to the user. In some embodiments, the user may be offered the option to add additional products that may be missing from the current skincare routine. Said the product efficacy system may select additional products from the product database based on the aforementioned machine learning algorithm.

One of the unique and inventive technical features of the present invention is the implementation of a machine learning algorithm based on expert informed data to order, optimize, and complete a user's current skincare routine. Without wishing to limit the invention to any theory or mechanism, it is believed that the technical feature of the present invention advantageously provides for automated and accurate recommendations to the user's skincare routine in a manner that best suits the user's personal attributes and maximizes product efficacy. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a system for accepting a skincare routine of a user and offering cosmetic products to complete said skincare routine in a manner that best suits the consumer's personal attributes and maximizes product efficacy.

FIG. 2 shows a flow chart of a method for accepting a skincare routine of a user and offering cosmetic products to complete said skincare routine in a manner that best suits the consumer's personal attributes and maximizes product efficacy.

FIGS. 3A-3Y show a plurality of examples of how a software application utilizing the present invention may operate.

FIG. 4A shows a flow chart of a method of the present invention for collecting data from the user to fill a user database. FIG. 4B shows a flow chart of a method of the present invention for collecting data to fill a product database of products. FIG. 4C shows a flow chart of a method of the present invention for analyzing products of the product database, categorizing variables, and determining functionality. FIG. 4D shows a flow chart of a method for determining a product's use in a cosmetic product routine for the user.

FIG. 5A shows an example table of data collected by the user for the user database. FIG. 5B shows an example table of weighted concerns collected from the user. FIG. 5C shows an example table of weighted properties of each product in the product database. FIG. 5D shows an example table mapping users from the user database to products in the product database. FIG. 5E shows an example table of routine steps mapped to product parameters. FIG. 5F shows an example table of products scored according to their function. FIG. 5G shows an example table mapping products from the product database to steps in a user-determined routine.

### DETAILED DESCRIPTION OF THE INVENTION

The present invention features a system for generating a cosmetic product routine suited to a user's preferences and attributes. The system may comprise a product database comprising a plurality of cosmetic products. Each cosmetic product may comprise one or more product attributes, a primary function, and one or more ingredients. The system may further comprise a user attribute database comprising one or more user preferences and one or more user attributes. The one or more user preferences may be weighted and ranked based on importance to the user. The system may further comprise a product efficacy component communicatively coupled to the product database and the user attribute database, comprising a processor capable of executing computer-readable instructions and a memory component comprising a plurality of computer-readable instructions.

The plurality of computer-readable instructions may comprise weighting, for each cosmetic product of the product database, an efficacy based on one or more functions, and generating a template routine comprising a plurality of steps each having a function ordered such that an efficacy of each function is maximized. The plurality of computer-readable instructions may further comprise determining, from the product database, through a machine learning algorithm, a plurality of suitable products for the user based on the one or more product attributes of each cosmetic product, the one or more user preferences and the one or more user attributes. The plurality of computer-readable instructions may further comprise filling the template routine with one or more selected cosmetic products from the plurality of suitable products. At least one cosmetic product may be selected for each step. The one or more selected cosmetic products may be selected based on the weighted efficacy and the primary function. The plurality of computer-readable instructions may further comprise displaying the cosmetic product routine to the user.

In some embodiments, the machine learning algorithm may be trained by expert informed data, hypothetical examples, and user reviews. The one or more product attributes may comprise claimed value, category, ingredients, ingredient percentage, price, size, solubility, chemical properties, and brand. The one or more user preferences comprise cleanliness of a product, whether or not a product is organic, whether or not a product is vegan, sustainability, price, and rating. The one or more user attributes may comprise age, sex, skin characteristics, goals, concerns, location, environment, and season. The primary feature of each cosmetic product may be selected from a group comprising toner, moisturizer, exfoliant, cleanser, colorizer, and active. The memory component may further comprise computer-readable instructions for accepting a partial cosmetic product routine from the user, identifying one or more missing steps in the partial cosmetic product routine, and filling the one or more missing steps with one or more cosmetic products from the plurality of suitable products wherein at least one cosmetic product may be selected for each step. The one or more selected cosmetic products may be selected based on the weighted efficacy and the primary function. The user attribute database may be filled by the user through a third party, a computing device, or a survey. Each cosmetic product may be weighted based on an efficacy of the claimed value. The product database may comprise products from only one brand or a plurality of brands.

The present invention features a method for generating a cosmetic product routine suited to a user's preferences and attributes. In some embodiments, the method may comprise accepting, from the user, one or more user preferences and one or more user attributes. The one or more user preferences may be weighted and ranked based on importance to the user. The method may further comprise providing a product database comprising a plurality of cosmetic products. Each cosmetic product may comprise one or more product attributes, a primary function, and one or more ingredients.

The method may further comprise weighting, for each cosmetic product of the product database, an efficacy based on one or more functions, and generating a template routine comprising a plurality of steps each having a function, ordered such that an efficacy of each function may be maximized. The method may further comprise determining, from the product database, through a machine learning algorithm, a plurality of suitable products for the user based on the one or more product attributes of each cosmetic product, the one or more user preferences and the one or more user attributes. The method may further comprise filling the template routine with one or more selected cosmetic products from the plurality of suitable products. At least one cosmetic product may be selected for each step. The one or more selected cosmetic products may be selected based on the weighted efficacy and the primary function. The method may further comprise displaying the cosmetic product routine to the user.

In some embodiments, the machine learning algorithm may be trained by expert informed data, hypothetical examples, and user reviews. The one or more product attributes may comprise claimed value, category, ingredients, ingredient percentage, price, size, solubility, chemical properties, and brand. The one or more user preferences comprise cleanliness of a product, whether or not a product is organic, whether or not a product is vegan, sustainability, price, and rating. The one or more user attributes may comprise age, sex, skin characteristics, goals, concerns, location, environment, and season. The primary feature of each cosmetic product may be selected from a group comprising toner, moisturizer, exfoliant, cleanser, colorizer, and active. The method may further comprise accepting a partial cosmetic product routine from the user, identifying one or more missing steps in the partial cosmetic product routine, and filling the one or more missing steps with one or more cosmetic products from the plurality of suitable products wherein at least one cosmetic product may be selected for each step. The one or more selected cosmetic products may be selected based on the weighted efficacy and the primary function. The user attribute database may be filled by the user through a third party, a computing device, or a survey. Each cosmetic product may be weighted based on an efficacy of the claimed value. The product database may comprise products from only one brand or a plurality of brands.

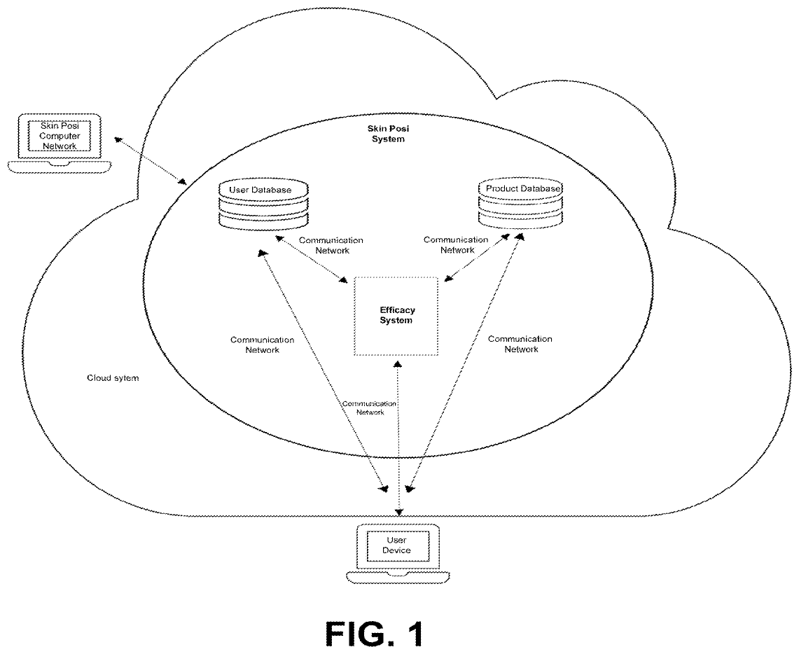

Referring now to FIG. 1, the present invention features a system for accepting a user's personal attributes and skincare routine in order to offer cosmetic products that complete said skincare routine in a manner that best suits the user's personal attributes and maximizes product efficacy. The system may comprise a consumer profile in communication with a device and a product efficacy system. The consumer profile may comprise personal attributes, products in the user's current skincare routine, an ordering of said products, and other relevant information. The device may be a phone, a personal computing device, or any other smart device capable of executing software applications. The product efficacy system may be in communication with the consumer profile and a product database. The product efficacy system may utilize machine learning based on a training set of potential characteristics of a user matched to ingredients that interact well with said user and other ingredients. The training set may comprise expert informed recommendations, hypothetical examples, and user reviews of products contained in the product database. Data from the consumer profile may be transmitted to the product efficacy system, which will utilize machine learning to select a plurality of products from the product database based on a plurality of product attributes that correspond to the plurality of consumer attributes and the skincare routine in order to reorder, optimize, and complete said skincare routine. The plurality of product attributes may comprise value propositions, product categories, and ingredients. The plurality of products selected by the product efficacy system may be displayed on the device.

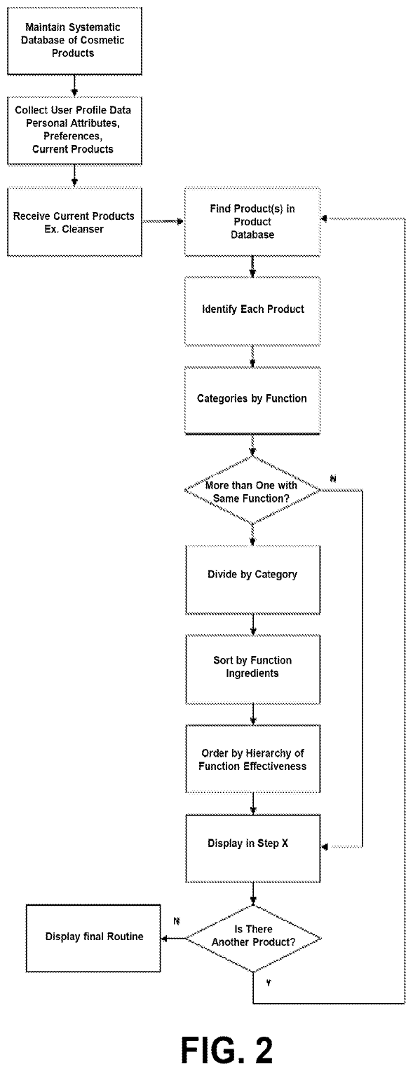

Referring now to FIG. 2, the present invention features a method for accepting a user's personal attributes and a skincare routine in order to reorder said skincare routine and offer cosmetic products to optimize and/or complete said skincare routine in a manner that best suits the user's personal attributes and maximizes product efficacy. The method may comprise maintaining a systematic product database of cosmetic products categorized based on a plurality of product attributes. The plurality of product attributes may comprise value propositions, product category, ingredients, solubility, and chemical properties. The method may further comprise receiving, from the user, a consumer profile comprising a plurality of consumer attributes. The plurality of consumer attributes may comprise a user's age, sex, skin characteristics, concerns, goals, preferences, and product ratings. The method may further comprise receiving, by a product efficacy system, a current skincare routine from the user. The skincare routine may comprise a list of cosmetic products. In some embodiments, the method may further comprise finding each cosmetic product of the skincare routine in the product database. In some embodiments, the method may further comprise identifying a function for each cosmetic product of the skincare routine. The product type may be selected from a list comprising cleanser, moisturizer, colorizer, and active. The method may further comprise categorizing each product of the skincare routine by function and identifying if more than one product has the same function. If more than one product has the same function, each product of the skincare routine may be divided into categories based on function. Each category with more than one cosmetic product may be sorted by how effective each product's functional ingredients are with respect to the data in the consumer profile and ordered into a hierarchy to be displayed to the user in order to choose a preferred product from said hierarchy. The plurality of products of the skincare routine are then reordered based on an optimal ordering of product categories. For example, an eye cream would be placed before a sunscreen in order to maximize product efficacy. This is repeated until each step has at most one product. The optimized skincare routine may be displayed to the user. In some embodiments, the user may be offered the option to add additional products that may be missing from the current skincare routine. Said the product efficacy system may select additional products from the product database based on the aforementioned machine learning algorithm.

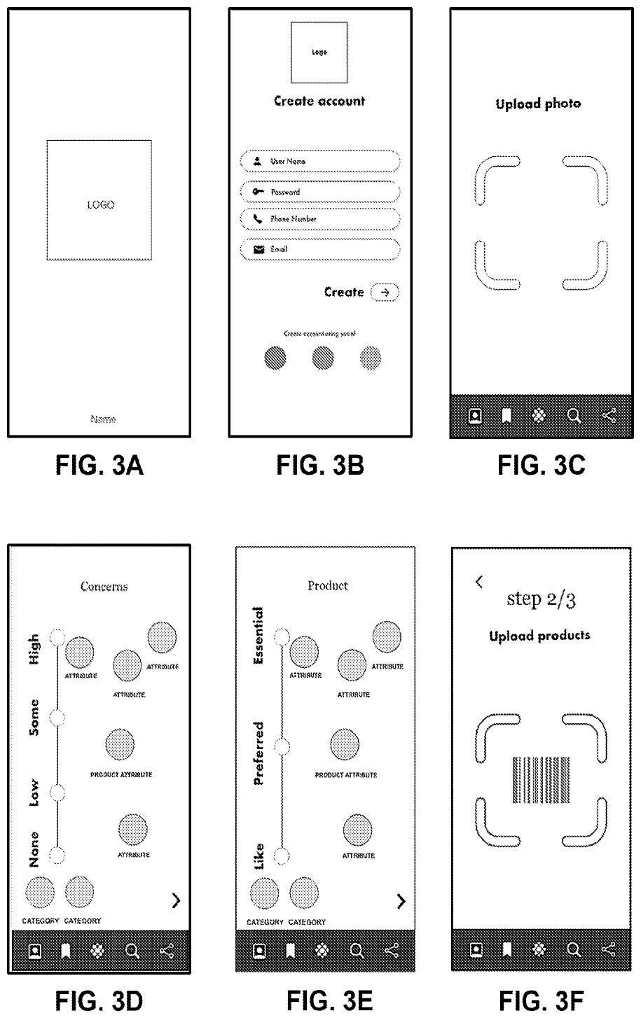

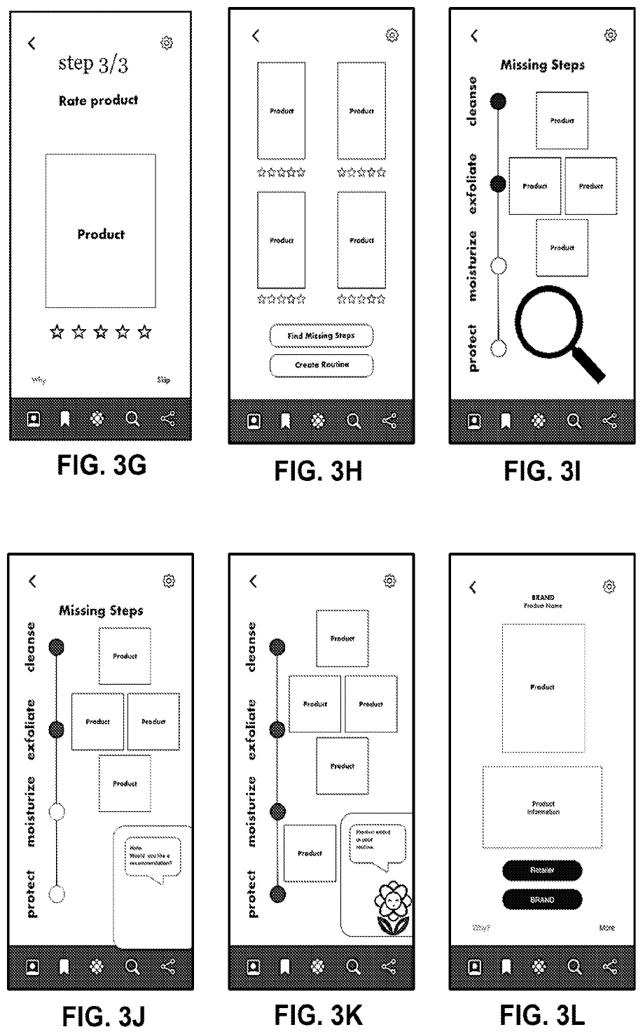

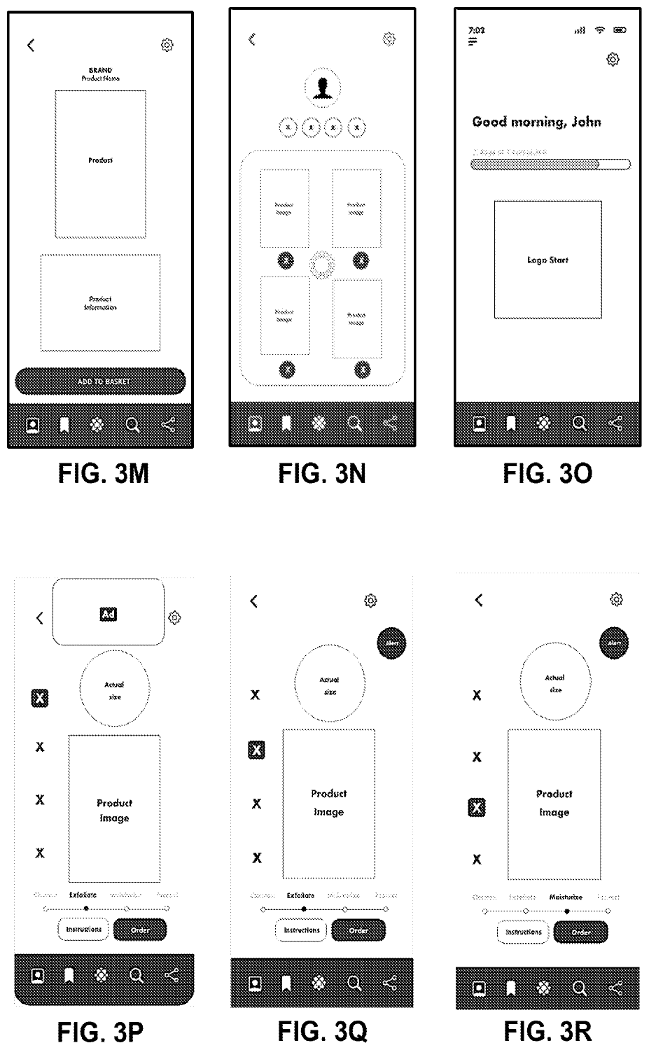

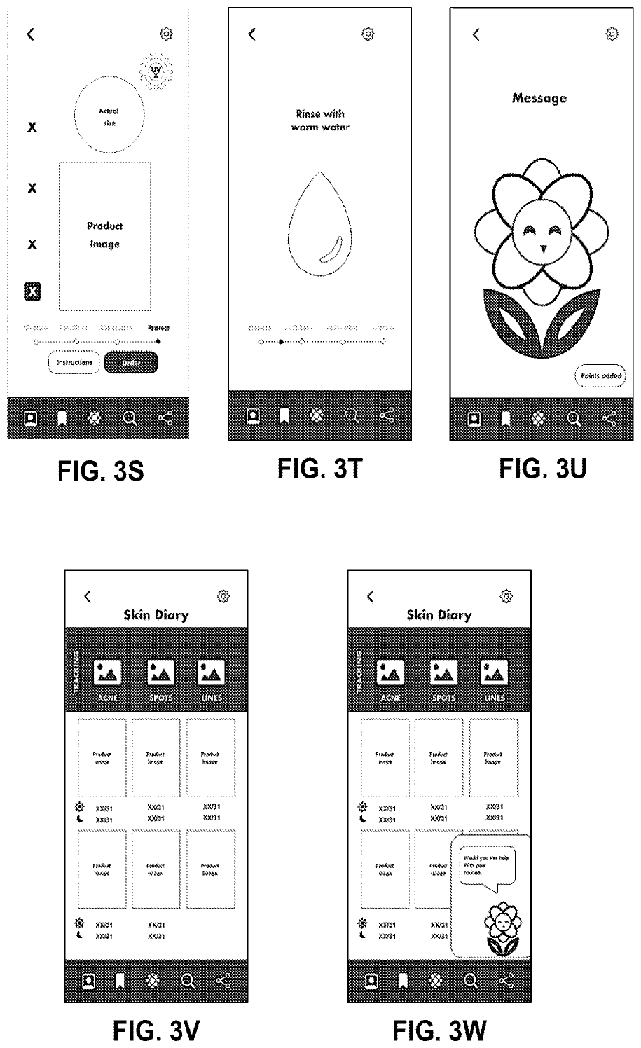

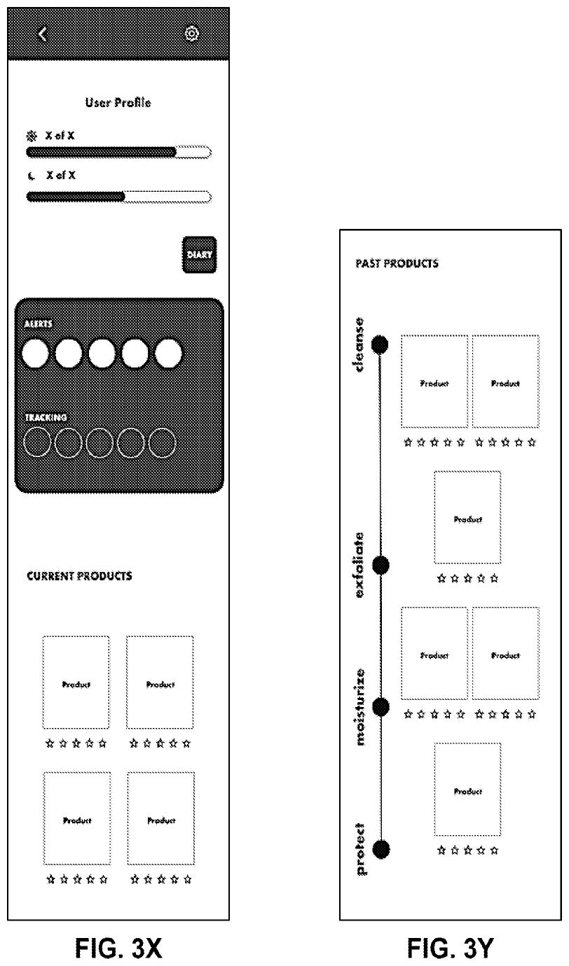

FIGS. 3A-3Y, show a plurality of examples of a software application implementing the system of the present invention. FIGS. 3A-3B shows an opening screen of the software application. As seen in FIG. 3C, the software application may request a photograph of a user in order to automatically recognize skin characteristics through the use of a facial recognition algorithm. FIG. 3D-3E show an example of ranking user preferences and product variables, respectively, in order to aid a product efficacy system in selecting and sorting products from a product database to be displayed to the user as components of a skincare routine. FIGS. 3F-3G show an example of uploading and rating cosmetic products currently used by the user in order to aid the product efficacy system in selecting and sorting products from the product database to be displayed to the user as components of the skincare routine. In some embodiments, uploading and rating cosmetic products currently used by the user may allow the system to fill in steps missing from the skincare routine, if necessary, as seen in FIGS. 3H-3K. FIGS. 3L-3M show a product page, comprising a price, description, ratings, and an option to order the product from one or more sources. FIG. 3N shows an example of the software application allowing the user to post a skincare routine to a social media platform. As seen in FIGS. 30-3T, the software application may guide the user through the skincare routine and track the user's progress over multiple days. FIG. 3U shows a congratulatory message for the user upon completion of a skincare routine. As seen in FIGS. 3V-3W, the software application may display tracking of the user's progress over multiple days in the form of a diary, showing how many times each product has been used over a month. FIG. 3W shows an option for the user to request help from the diary. In some embodiments, this may entail requesting a replacement for a product, ordering a refill for a product, and asking why a user's concern has not been cured by the skincare routine. FIG. 3X shows another example of tracking the user's progress over multiple days as well as currently used products. FIG. 3Y shows an example of a previously used step-by-step skincare routine, displayed to the user.

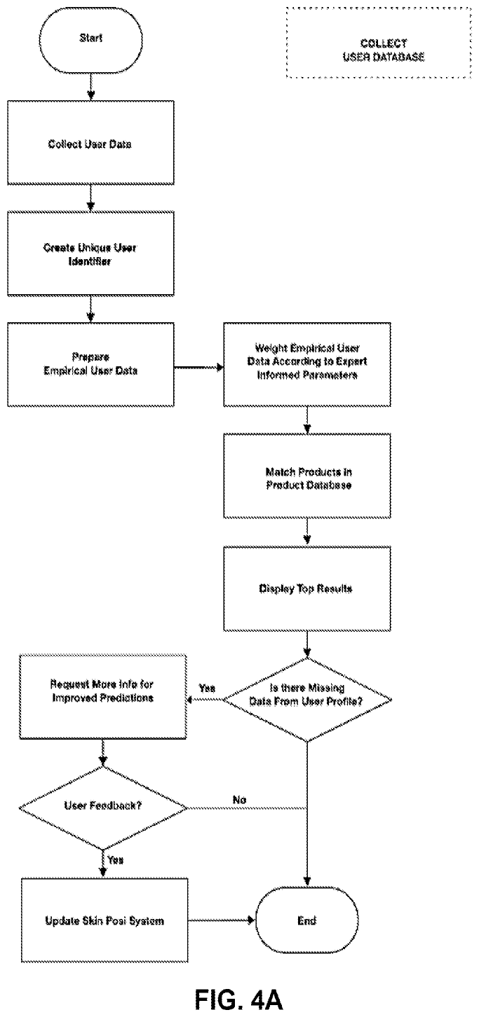

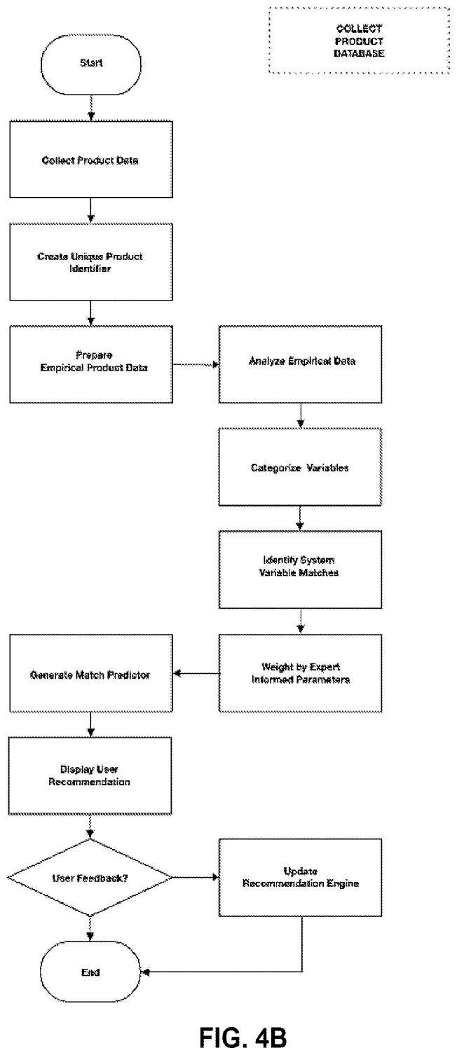

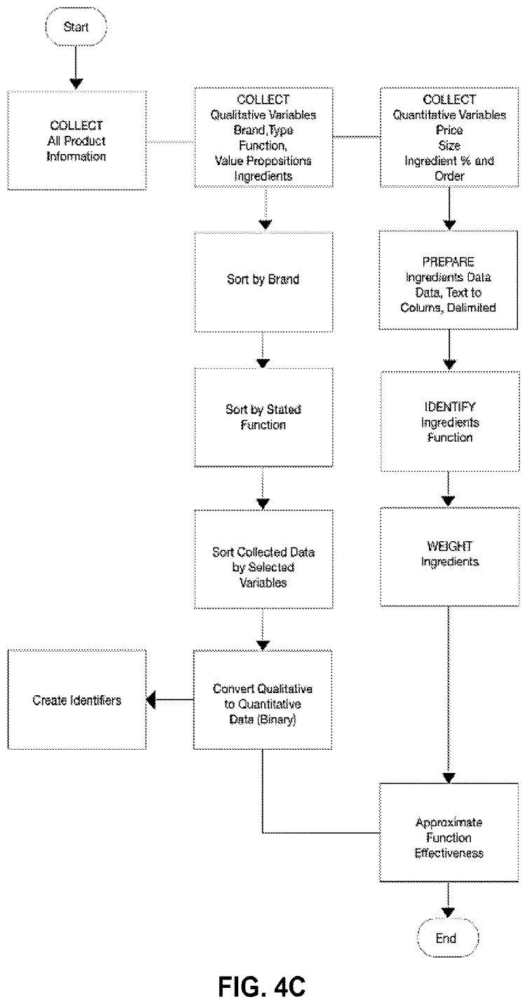

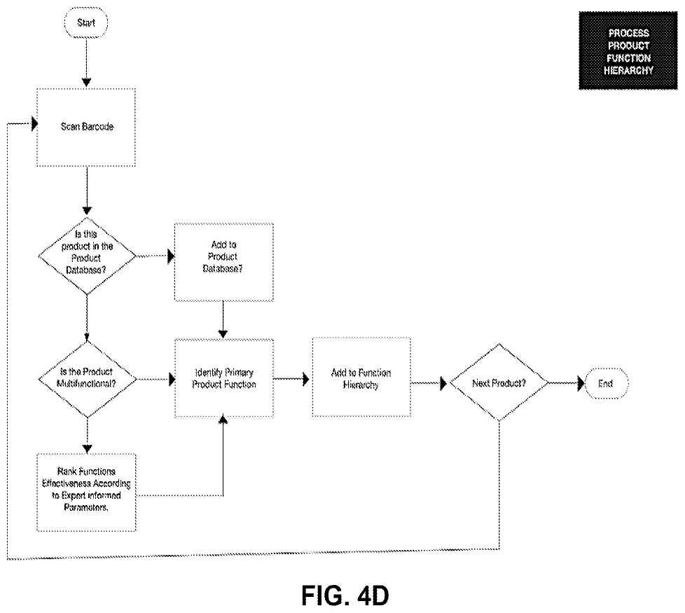

Referring now to FIG. 4A, the present invention features a method for collecting data from the user to fill a user database. The method may comprise collecting data from the user (age, sex, color, skin moistness, etc.), creating a unique user identifier, and preparing empirical data relating to the user's submitted data (e.g. how certain product features affect users with certain characteristics). The method may further comprise weighting the empirical user data according to expert informed parameters (e.g. a board of experts, prior data/studies, etc.). The method may further comprise matching products from the product database to the user based on the empirical data and user data such that the selected products can be used by the user in a cosmetic product routine. The method may further comprise displaying the top results of matching products to the user. If there is missing data from the user profile that may aid in product selection, more info may be requested from the user. In some embodiments, the system may request user feedback on certain products, contributing to the user empirical data and allowing the product database to be updated accordingly, affecting the weighting of products that are rated by the user.

Referring now to FIG. 4B, the present invention features a method for collecting data to fill a product database of products. The method may comprise collecting product data from a pre-existing list of cosmetic products, creating a unique product identifier for each product collected, and preparing empirical data relating to the product data (e.g. how certain product features affect certain users). The method may further comprise analyzing the product empirical data and categorizing variables of each product based on the analysis. The method may further comprise identifying system variable matches to establish a list of variables that a product can be identified with, and weighting each determined variable based on expert-informed parameters. The method may further comprise generating a match predictor for mapping products to users based on the list of variables and possible user parameters. The method may comprise displaying one or more user recommendations for products based on the generated match predictor. The method may further comprise displaying recommendations of products to users that match to the said products. In some embodiments, the system may request user feedback on certain products, contributing to the product empirical data and allowing future recommendations to be updated accordingly, affecting the weighting of products that are rated by the user.

Referring now to FIG. 4C shows a flow chart of a method for analyzing products of the product database to be recommended to the user. The method may comprise collecting all product information for the product database, and collecting a plurality of variables. Collecting the plurality of variables may comprise collecting qualitative variables (e.g. brand, type, function, value, propositions, ingredients). Collecting qualitative variables may comprise sorting the products by brand, sorting the products by stated function, and sorting collected data by user-selected variables. These qualitative variables may be converted into binary quantitative data. Identifiers may be created for each qualitative variable. Collecting the plurality of variables may further comprise collecting quantitative variables (e.g. price, size, ingredient %, order in a routine). Collecting the quantitative data may comprise preparing ingredient data into a table, identifying the function of each ingredient, and weighting each ingredient with regards to the product as a whole. The method may further comprise approximating function effectiveness of each product based on the plurality of variables.

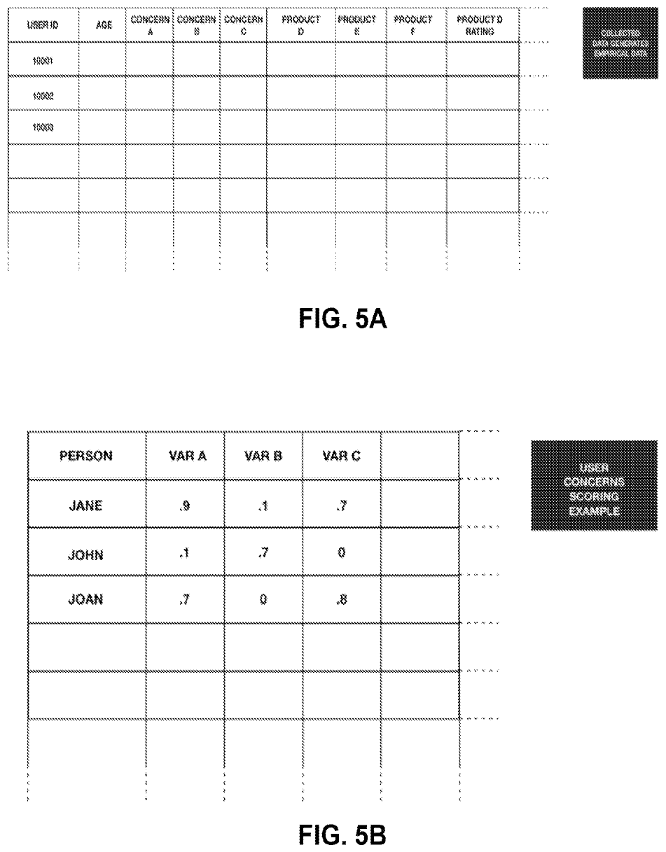

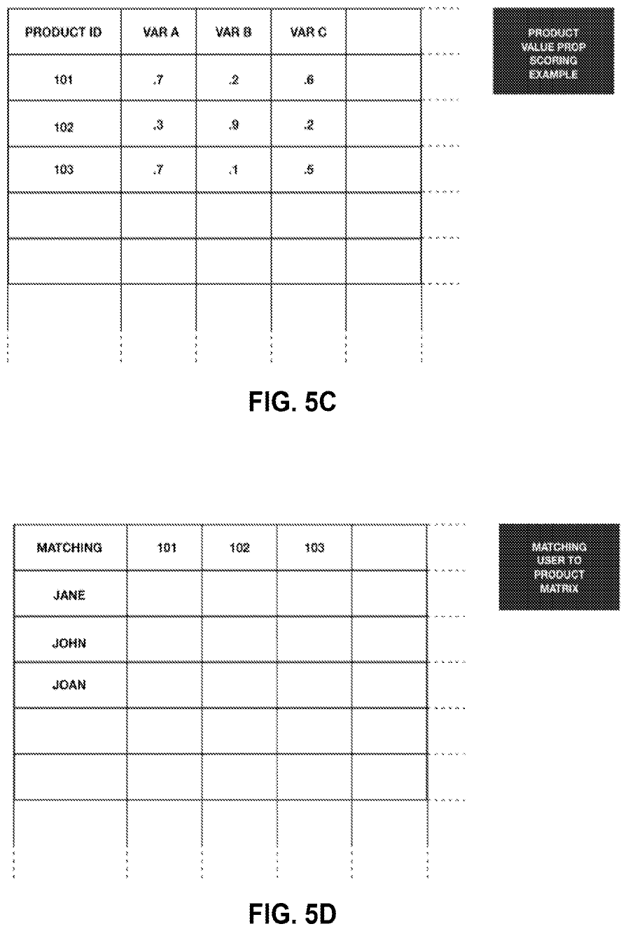

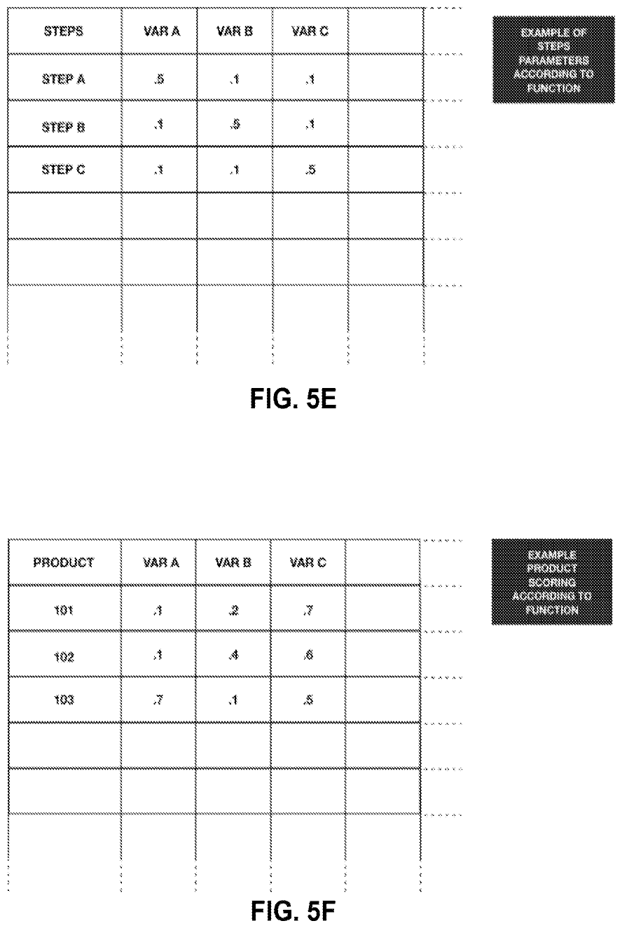

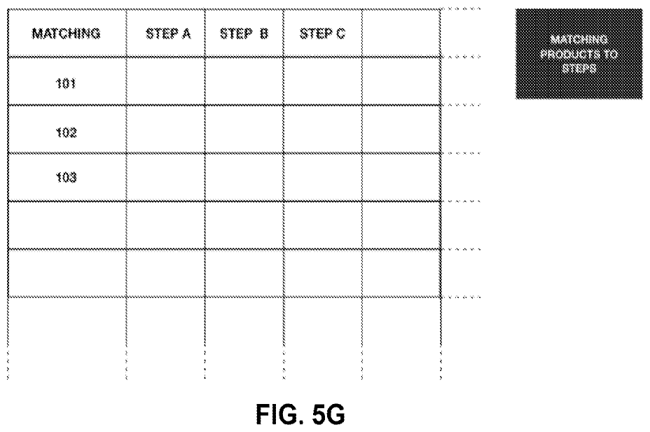

Referring now to FIG. 4D, the present invention features a method for determining a product's use in a cosmetic product routine for the user. The method may comprise scanning a barcode of a product and determining whether or not the product is in the product database.if it isn't, then the method may further comprise adding the product to the product database. If it is in the product database, then the method may further comprise determining whether the product is multifunctional or not. If the product is multifunctional, then the effectiveness of each function may be ranked according to expert informed parameters. The method may further comprise identifying the product's primary function. The product may then be added to the product hierarchy, and the user may then be queried for additional products to add to the hierarchy. The product hierarchy is depicted in FIG. 5E and may be determined by prior data. For example, spray toner is always used before moisturizer to maximize the effectiveness of both. Solubility, interactions, and functions are all taken into account for this.

Referring now to FIGS. 5A-5G, the present invention implements a plurality of tables in multiple databases for storing user and product data, weighted product features and ingredients, and products mapped to users and their routines. FIG. 5A shows a table of collected user data used to generate empirical data. This empirical data may be used to determine product recommendations for others. FIG. 5B shows a table of users mapped to their concerns to be met in product selection. Each user concern has a certain weight that is used to determine what variables products from the product database must have to be recommended to the said user. FIG. 5C shows a table of products weighted by their efficacy at their claimed function (e.g. a product that lists itself as a moisturizer will be weighted based on its moisturizing capabilities). FIG. 5D shows a table mapping users to products that meet their concerns. FIG. 5E shows a table mapping steps to a cosmetic routine (cleanser, exfoliant, moisturizer, toner, etc.) to determine the optimal routine structure to recommend to users. FIG. 5F shows a table mapping products from the product database to their efficacy at their primary function. FIG. 5G shows a table mapping products from the product database to various steps in a cosmetic product routine.

In some embodiments, the present invention may be employed by pre-existing shopping sites, such as Amazon. In some embodiments, the present invention may be linked to one or more dermatology clinics in order to revise a user's skincare routine in a period before a visit to said one or more dermatology clinics. For example, any stripping products will be removed from the user's skincare routine in the period before the visit. In some embodiments, the product database may comprise products relating to skincare, nail care, hair care, and/or color cosmetics. The user attribute database as well as the product database may be contained in one or more computing devices comprising at least a memory component capable of storing data. The one or more computing devices may be selected from a group consisting of mobile devices, personal computing devices, and cloud servers.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A system for generating a cosmetic product routine suited to a user's preferences and attributes, the system comprising:
a. a product database comprising a plurality of cosmetic products;
wherein each cosmetic product comprises one or more product attributes, a primary function, and one or more ingredients;
b. a user attribute database comprising one or more user preferences and one or more user attributes;
wherein the one or more user preferences are weighted and ranked based on importance to the user; and
c. a product efficacy component communicatively coupled to the product database and the user attribute database, comprising a processor capable of executing computer-readable instructions and a memory component comprising a plurality of computer-readable instructions for:
i. weighting, for each cosmetic product of the product database, an efficacy based on one or more functions;
ii. generating a template routine comprising a plurality of steps each having a function, ordered such that an efficacy of each function is maximized;
iii. determining, from the product database, through a machine learning algorithm, a plurality of suitable products for the user based on the one or more product attributes of each cosmetic product, the one or more user preferences and the one or more user attributes;
iv. filling the template routine with one or more selected cosmetic products from the plurality of suitable products;
wherein at least one cosmetic product is selected for each step;
wherein the one or more selected cosmetic products are selected based on the weighted efficacy and the primary function; and
v. displaying the cosmetic product routine to the user.

2. The system of claim 1, wherein the machine learning algorithm is trained by expert informed data, hypothetical examples, and user reviews.

3. The system of claim 1, wherein the one or more product attributes comprise claimed value, category, ingredients, ingredient percentage, price, size, solubility, chemical properties, and brand.

4. The system of claim 1, wherein the one or more user preferences comprise cleanliness of a product, if a product is organic, if a product is vegan, sustainability, price, and rating.

5. The system of claim 1, wherein the one or more user attributes comprise age, sex, skin characteristics, goals, concerns, location, environment, and season.

6. The system of claim 1, wherein the primary feature of each cosmetic product is selected from a group comprising toner, moisturizer, exfoliant, cleanser, colorizer, and active.

7. The system of claim 1, wherein the memory component further comprises computer-readable instructions for:
a. accepting a partial cosmetic product routine from the user;
b. identifying one or more missing steps in the partial cosmetic product routine; and
c. filling the one or more missing steps with one or more cosmetic products from the plurality of suitable products wherein at least one cosmetic product is selected for each step;
wherein the one or more selected cosmetic products are selected based on the weighted efficacy and the primary function.

8. The system of claim 1, wherein the user attribute database is filled by the user through a third party, a computing device, or a survey.

9. The system of claim 3, wherein each cosmetic product is weighted based on an efficacy of the claimed value.

10. The system of claim 1, wherein the product database comprises products from only one brand.

11. A method for generating a cosmetic product routine suited to a user's preferences and attributes comprising:
a. accepting, from the user, one or more user preferences and one or more user attributes;
wherein the one or more user preferences are weighted and ranked based on importance to the user;
b. providing a product database comprising a plurality of cosmetic products;
wherein each cosmetic product comprises one or more product attributes, a primary function, and one or more ingredients;
c. weighting, for each cosmetic product of the product database, an efficacy based on the one or more functions;
d. generating a template routine comprising a plurality of steps each having a function, ordered such that an efficacy of each function is maximized;
e. determining, from the product database, through a machine learning algorithm, a plurality of suitable products for the user based on the one or more product attributes of each cosmetic product, the one or more user preferences and the one or more user attributes;
f. filling the template routine with one or more selected cosmetic products from the plurality of suitable products;
wherein at least one cosmetic product is selected for each step;
wherein the one or more selected cosmetic products are selected based on the weighted efficacy and the primary function; and
g. displaying the cosmetic product routine to the user.

12. The method of claim 11, wherein the machine learning algorithm is trained by expert informed data, hypothetical examples, and user reviews.

13. The method of claim 11, wherein the one or more product attributes comprise claimed value, category, ingredients, ingredient percentage, price, size, solubility, chemical properties, and brand.

14. The method of claim 11, wherein the one or more user preferences comprise cleanliness of a product, if a product is organic, if a product is vegan, sustainability, price, and rating.

15. The method of claim 11, wherein the one or more user attributes comprise age, sex, skin characteristics, goals, concerns, location, environment, and season.

16. The method of claim 11, wherein the primary feature of each cosmetic product is selected from a group comprising toner, moisturizer, exfoliant, cleanser, colorizer, and active.

17. The method of claim 11 further comprising:
a. accepting a partial cosmetic product routine from the user;
b. identifying one or more missing steps in the partial cosmetic product routine; and
c. filling the one or more missing steps with one or more cosmetic products from the plurality of suitable products wherein at least one cosmetic product is selected for each step;
wherein the one or more selected cosmetic products are selected based on the weighted efficacy and the primary function.

18. The method of claim 11, wherein the one or more user preferences and the one or more user attributes are retrieved from the user through a third party, a computing device, or a survey.

19. The method of claim 13, wherein each cosmetic product is weighted based on an efficacy of the claimed value.

20. The method of claim 11, wherein the product database comprises products from only one brand.
